(19) United States
(12) Patent Application Publication
(10) Pub. No.: US 2010/0194669 A1
(43) Pub. Date: Aug. 5, 2010

(54) LED DISPLAY HAVING VARIABLE PIXEL SPACING

(75) Inventor: Claus Ellevang Hansen, Hornslet (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: MARTIN PROFESSIONAL A/S, Aarhus N (DK)

(21) Appl. No.: 12/665,542

(22) PCT Filed: Nov. 6, 2008
(86) PCT No.: PCT/DK2008/050270

§ 371 Date: Dec. 18, 2009

(30) Foreign Application Priority Data
Nov. 9, 2007 (DK) PA 2007 01581

(51) Int. Cl. G09G 3/00

(52) U.S. Cl. 345/31

(57) ABSTRACT

A light diode display (2) that may contain a large number of pixels (6), the pixels (6) may contain a number of light diodes that may produce light of different colour, where the light diodes may be electrically connected to a power supply, and where the pixels or the light diodes may likewise communicate with a control unit, wherein the individual pixels (6) interact with a flexible mechanical construction, the construction consisting of a number of interactive rods, where the rods may be connected with each other by swivel joints, and where light diode pixels (6) may advantageously be provided on the swivel joints.

### FIELD OF THE INVENTION

The invention concerns a light diode display containing a large number of pixels, the pixels containing a number of light diodes, the light diodes producing light of different colour, where the light diodes are electrically connected to a power supply, and where the pixels or the light diodes also communicate with a control unit.

### BACKGROUND OF THE INVENTION

Existing LED video displays on the market are made in different versions as fixed frame modules which are combined into the desired screen size or as flexible fabric or mesh displays that are easily folded or collapsed. However, not all LED video display are made with an individually determined pixel spacing, and the applicability of a screen thus depends on this fact. The greater pixel spacing, the farther away from the screen you have to be in order to get a functional image.

Therefore, as a rental company it is necessary to invest in several LED video screens as all application needs have to be covered. This means more big product investments and greater expenses for storing them.

To this is added that the existing LED video displays for entertainment purposes are static products that only show a graphic image. Frequently, the display will just hang in motor cranes, and the only possibility of varying the scene setup is to move the screen up and down by these cranes.

The existing LED video displays on the market today are focused on the combination flexibility (modularity), mounting and dismounting speed, coupling methods, size and weight. Time is money, and everything on these video displays thus has to be easily and rapidly performed.

U.S. Pat. No. 4,809,471 concerns a folding display which contains a net of horizontal and vertical rods for forming a stand of three-dimensional cells. The cells have eight corners with a separate item at each of the corners of the cell. The stand forming each cell has a top section, a bottom section and two side sections. Each section of the stand is formed by two interacting rods which are interconnected midway between their ends. The ends of the rods in each cell are fastened to associated items. Opposing cells in the stand share common rods and items. WO 99/49442 and U.S. Pat. No. 6,981,350 describe corresponding display systems.

### OBJECT OF THE INVENTION

The object of the present invention is to provide the possibility of varying the pixel spacing on a light diode video display, e.g. as a static option during the setting up of the display, or as a controllable pitch feature during the performing of an event.

A further object is to add horizontal and vertical movement of the entire video screen in order to impart greater application and entertainment value to the display.

### DESCRIPTION

This may be achieved by a light diode display as specified in the preamble of claim 1, if the individual pixels interact with a flexible mechanical construction consisting of a number of interactive rods, where the rods are interconnected by swivel joints, and where pixels are provided on the swivel joints.

Hereby may be achieved that a change of the size of the display can be effected by turning the rods in relation to the swivel joints. If the turning occurs synchronously for the entire display, a uniform extension will take place, whereby the distance between the individual pixels is increased without any substantial angular change of the angle necessarily existing between individual pixels. Hereby it becomes possible to unfold a reasonably large video wall very fast, where the video wall itself can be ready for showing images as soon as an electric connection of the individual pixels or light diodes has been performed. This may be effected centrally depending on how e.g. cabling is provided. Power cables may thus be laid out to each single pixel, while each single pixel communicates by electronic or optical communication means with a central electronic controller providing for the actual performing of a video presentation.

The rods may advantageously contain at least the electric connections to pixels or to light diodes. By running the electric connections inside the rods, it is achieved that the electric connections are well protected against common weather action by use in the outdoors, but at the same time there is achieved the advantage that electromagnetic shielding of the electric conductors is achieved. This may be advantageous if a data bus, e.g. together with a power connection, is to be run up to the individual pixels. Disturbing electric fields may destroy data communication over a bus connection if the radiation becomes too strong. However, by conducting the signals inside the rods, it will largely reduce the possibility of radiation of electric noise. Also, due to the shielding effect of the rods, no substantial radiation in connection with use of the light diode display will occur.

In a preferred embodiment, the mechanical construction may be designed as a frame formed of cells, where the size of the cell is adjustable by changing the distance between two of the joints of the cell. By making the construction as a number of interacting cells, it is achieved that the joints of all cells are moving simultaneously during unfolding and holding together, such that the distance can be adjusted with any angular displacement of the individual joints. In that a rod interacts with two joints, there will be at least two mechanical rods connected to each single joint. In that pixels are advantageously disposed at the joints where cell rods are interconnected. Both power and data bus are advantageously provided inside the rods. Since each individual pixel does not have to be connected with e.g. a data bus and a power supply, it is, however, possible to perform the invention by means of pixels where there is only provided a single live conductor within the rods, whereas the rods themselves form an earth connection, and where the individual pixels communicate with a controller via wireless electronic or optical communication means, whereby no data are to be transmitted via the cabling. In another possible embodiment, all communication with the individual pixels occurs by means of high frequency modulation of data signals which are superposed the power supply.

The mechanical construction of a frame in the form of a number of interacting cells may contain a scale between at least two joints. By providing a scale between joints in a cell, it will be easy by the scale to perform correct setting of the size of the frame. The measuring scale may simply contain a scale in mm or an indication of size and width, such that it becomes possible to accurately adjust the individual frame, which is advantageous if more frames are to interact by showing the same video sequence.

The frame may advantageously contain at least one actuator for adjusting the size. Using an actuator, e.g. in connection with a screw or worm connection between the joints of a cell, may provide that it becomes possible to perform setting of the size of the frame in a very simple and accurate way.

The actuator of the frame may interact with a motor regulated by a control unit, where a position detector transmits a signal depending on the actual size of the cell to the control unit, and where the control unit regulates the motor to the desired size of the cell and thereby the size of the frame. In a preferred embodiment, the actuator is connected to a motor such that the setting may be effected automatically. By simultaneously providing that a regulating unit communicates with a response signal, an automatic setting for the desired size may be achieved.

The individual pixels may communicate mutually or by a controller via two-way wireless communication. Hereby may be achieved that data do not have to be transmitted in the cell rods.

Advantageously, communication between pixels may take place by IR communication. Based on the fact that the angle between pixels is constant, and that the spacing has a maximum size, IR communication can be used for two-way high-speed IR communication.

The rods of the frame may advantageously be made of completely or partially transparent material. With transparent rods, the frame becomes partially transparent from the back side.

The rods of the frame may contain light diodes. If the rods are transparent, one or more light diodes, possibly in a row, may emit light from the rods.

The rods of the frame may be provided with holes for accommodating light diodes. Light diodes may hereby be disposed directly in the rods, and the light diodes may be powered by cabling hidden in the rods.

### DETAILED DESCRIPTION

FIG. 1 shows a first embodiment of a collapsed frame consisting of cells according to the invention.

FIG. 2 shows the same frame as in FIG. 1, but unfolded to a first display size.

FIG. 3 shows the same frame as in FIG. 1 or 2, but here as a completely unfolded cell.

FIG. 4 shows a first alternative embodiment of a frame, as seen from the side.

FIG. 5 shows the same embodiment as FIG. 4, but there partially unfolded.

FIG. 6 shows a second alternative embodiment as seen from the side.

FIG. 7 shows an enlarged detail of the embodiment shown on FIG. 6.

### DESCRIPTION OF THE DRAWING

FIG. 1 shows a first embodiment of a collapsed frame 2 according to the invention. FIG. 1 shows the frame 2 as seen from the side. A person 4 is shown at the side of the frame 2. The frame 2 is designed with light diode pixels 6 at the forward facing side.

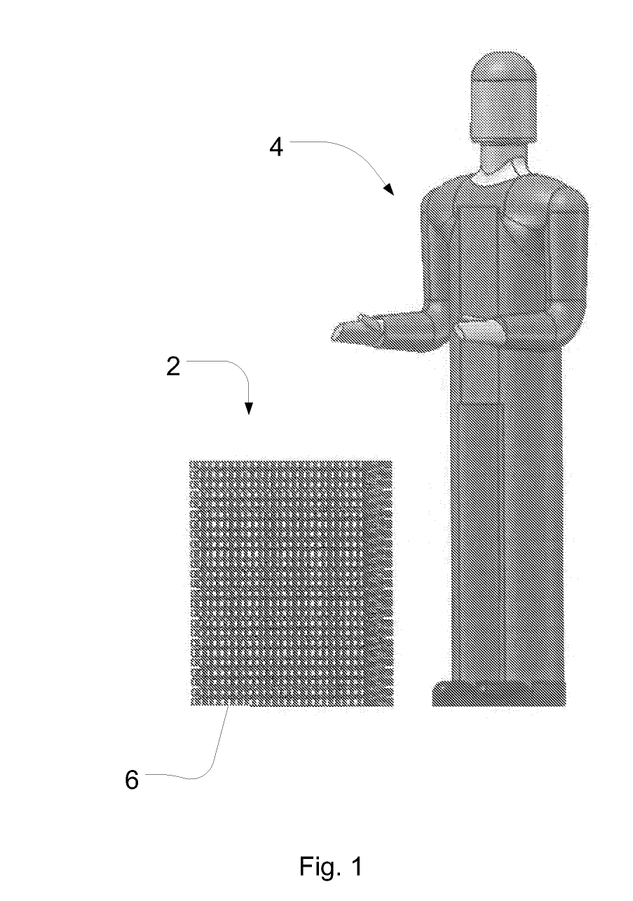

FIG. 2 shows the same frame as in FIG. 1, but unfolded. The frame 2 here is shown considerably larger than the person 4. At the same time, a spacing between pixels 6 has appeared.

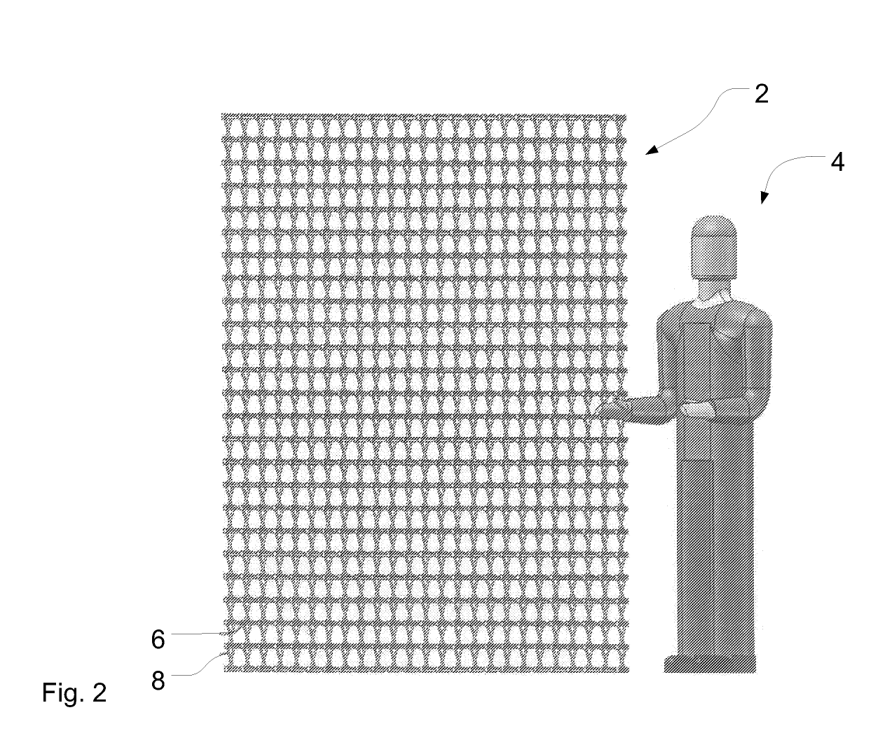

FIG. 3 shows the same frame as in FIG. 1 or 2, but here seen from the front. It appears from FIG. 3 that the rods 8 now forms squares where pixels 6 are found at all corners of the squares.

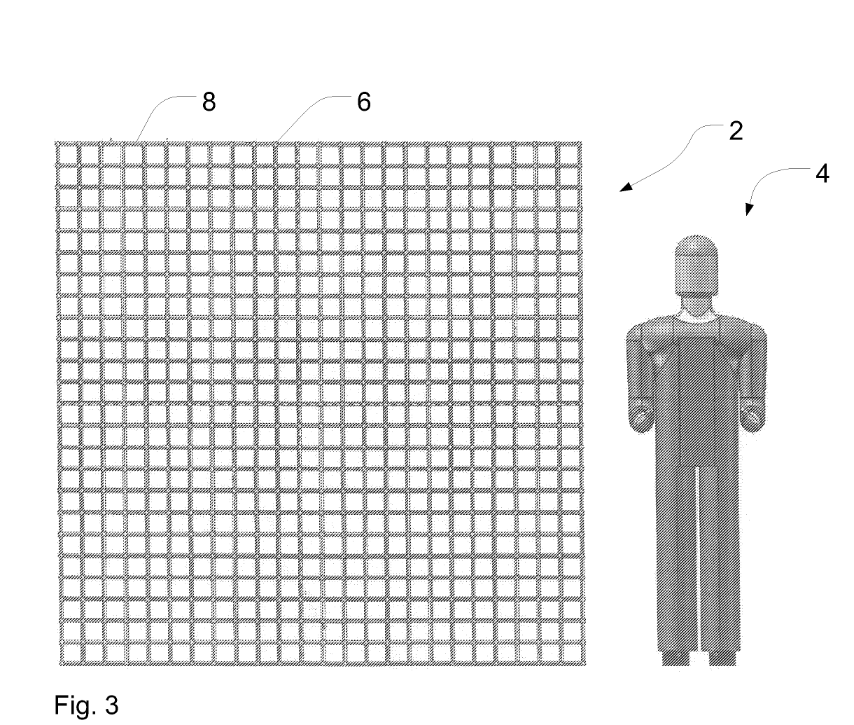

FIG. 4 shows a first alternative embodiment of a frame 102, as seen from the side. The frame 102 displays surfaces 106 which may be provided with light diode pixels (not shown). The surfaces 106 are part of swivel joints 110 which via rods 108 are connected with swivel joints 112.

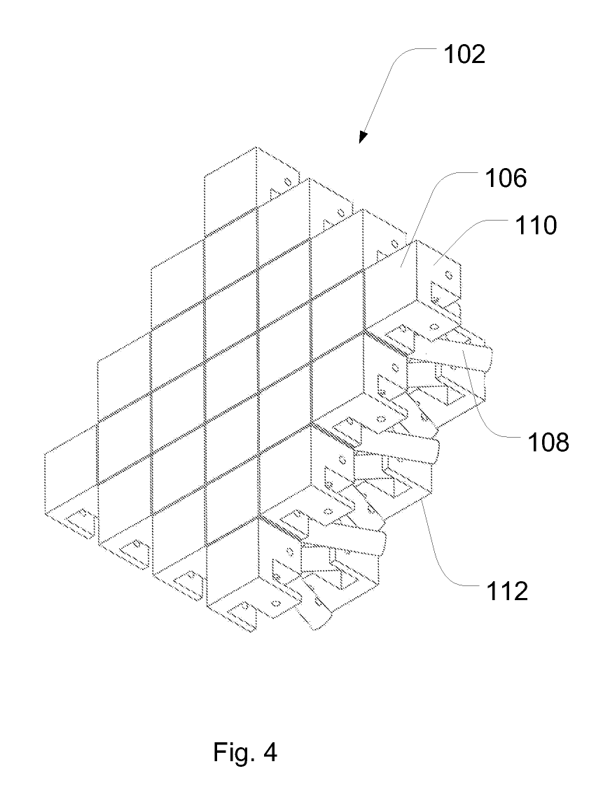

FIG. 5 shows the same embodiment as FIG. 4, but the frame 102 is here partially unfolded. This appears from the fact that the rods 108 on FIG. 4 have changed their angle in relation to the rods 108 on FIG. 3. At the same time, a visible spacing between pixels 110 is now present.

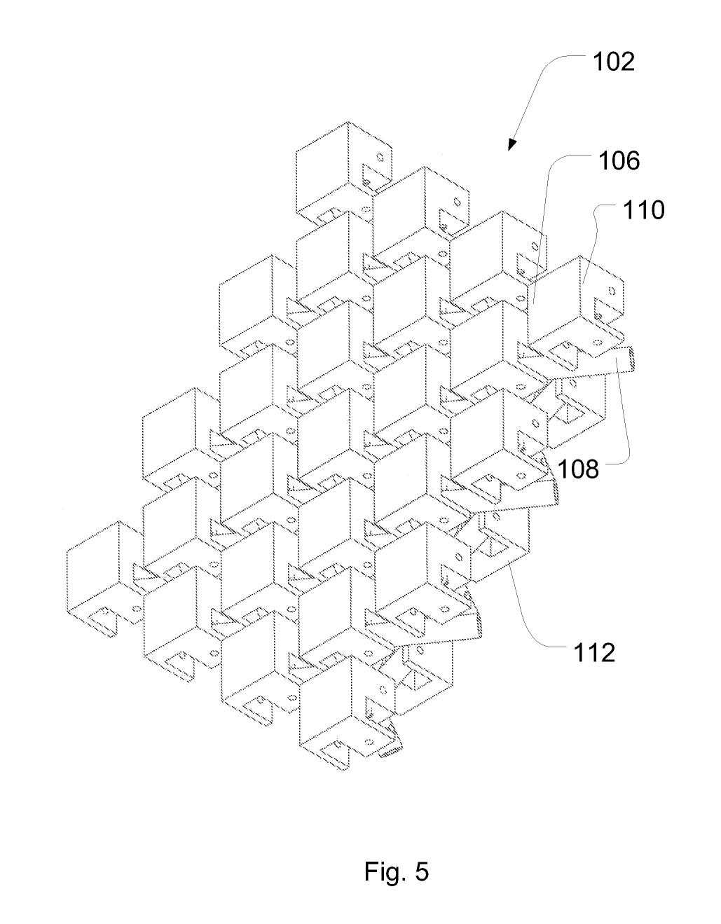

FIG. 6 shows a second alternative embodiment of a frame 202 as seen from the side. The frame has swivel joints 210 which are designed with a surface 206 for mounting pixels. Swivel joints 210 have mechanical and possibly electric connection through a rod 208 to swivel joints 212.

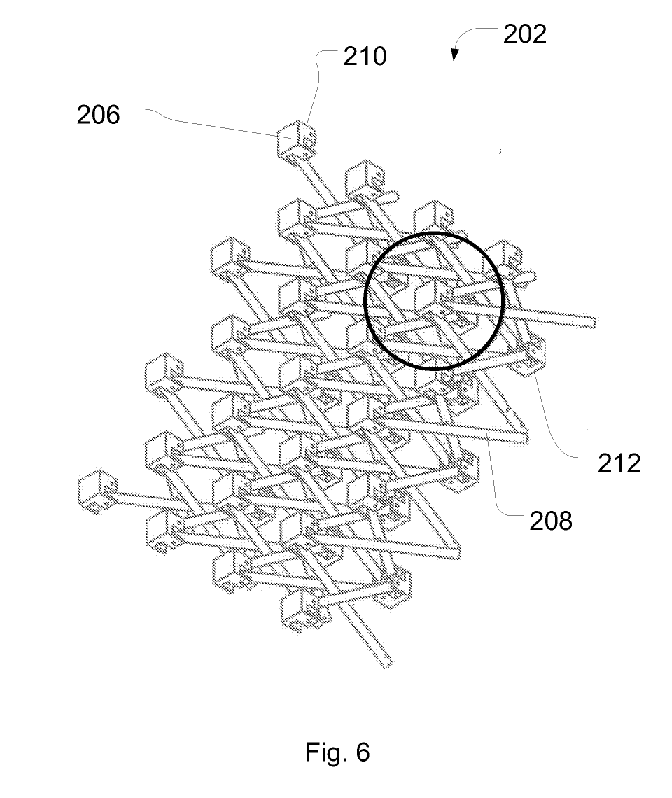

FIG. 7 shows an enlarged detail of the embodiment of the frame 202 shown on FIG. 6.

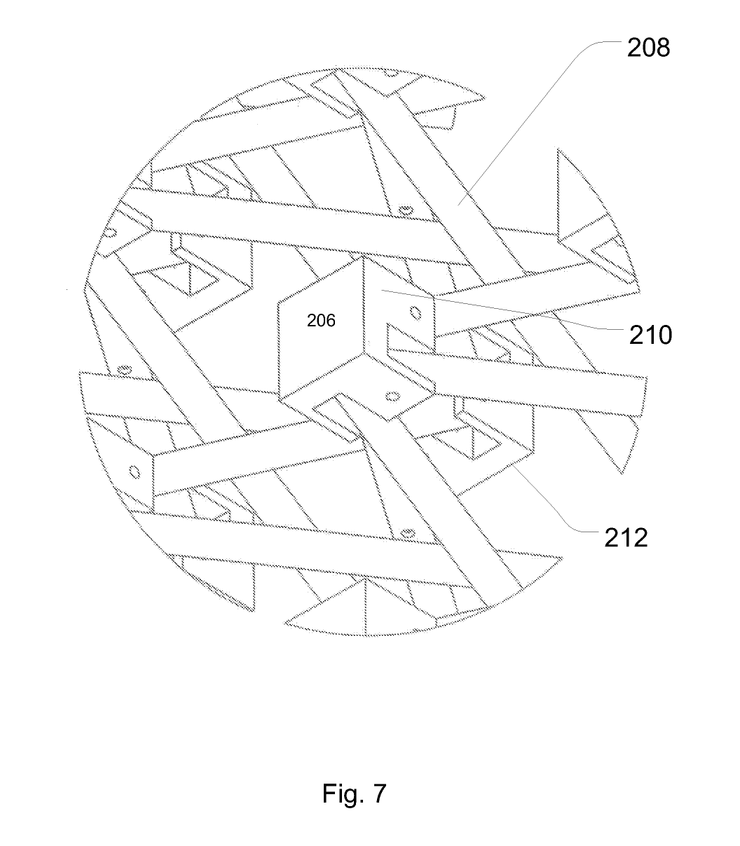

FIG. 8 shows a second alternative embodiment of a frame 302 with a number of cells as seen from the side. The frame 302 displays surfaces 306 which may be provided with light diode pixels (not shown). The surfaces 306 are part of swivel joints 310 which via rods 308 are connected with swivel joints 312. The rods 308 will change their angle in relation to swivel joints 310 and 312 when the frame is unfolded or collapsed in a way corresponding to that shown in FIGS. 4, 5 and 6. Swivel joints 310 and 310′, which are disposed at opposite sides of the frame about opposite each other, are additionally connected by variable rods 314. The variable rods may be varied in length and will be extended when the frame is unfolded, and shortened when the frame is collapsed or folded. The variable rods may e.g. be designed as two telescoping rods where one slides into the other, and may in addition include a locking mechanism which may lock the two telescoping rods in relation to each other, whereby the stability of the frame is enhanced. The locking mechanism may e.g. be a knob which is resiliently mounted on the inner telescoping rod, and which may be inserted in a hole in the outer telescoping rod; such a system is known i.a. from tent poles. The locking mechanism may also be designed as a screw mechanism, which e.g. can clamp the outer telescoping rod to the inner telescoping rod; such mechanisms are i.a. known from cleaning handles/sticks.

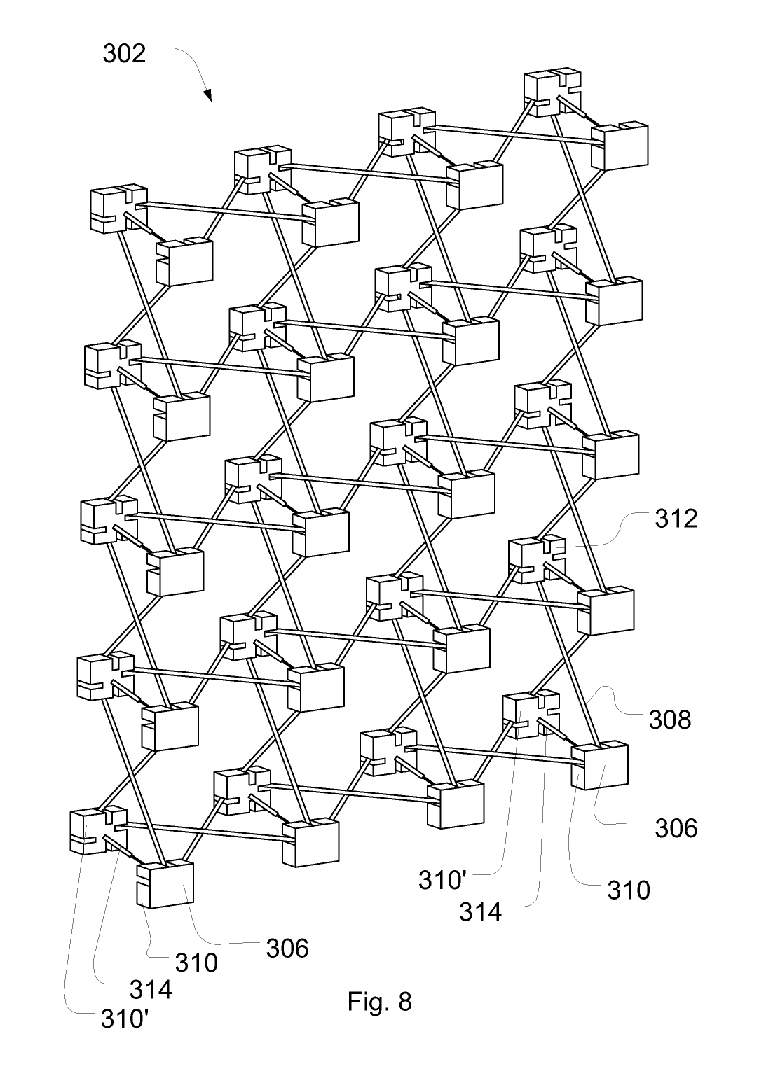

A number of the variable rods may in an embodiment be constituted by one or more linear actuators which automatically can unfold and collapse the frame when activated.

Besides, a double LED display may be constructed by providing the swivel joints at both sides of the frame with LED pixels. The two displays may be controlled by the same control unit or two different control units. By both solutions it is possible to control both displays such that the same image is shown on both displays or such that different images are shown on the two displays.

As described above, it is possible to connect the light diodes through the rods, but in an alternative embodiment, the joints/swivel joints include a fitting to which a light diode may be fastened. An LED array including a number of light diode pixels connected to power supply wires and control wires may thus be fastened to the frame by fastening the light diodes to the joints. In that case, the length of wire between each single light diode will determine how large the display can become. This may be solved by letting the wire length between individual light diodes exceed the largest pixel spacing to which the frame may be unfolded.

In order to enable varying the pixel spacing of the light diode video display, a special mechanical structure is used as the chassis of the display. The mechanical structure is a kind of 3D cell construction where the height, width and depth of the chassis may be determined by varying the distance between two joints in the structure. If the joint distance is increased, the height, width and depth are increased via the cell method. The invention provides placing pixels at the joints at one side of this cell chassis frame. By varying the distance between two joints, the spacing between pixels may now be adjusted according to need.

All wiring may be carried in the tubing of the cell structure, as no lengths are increased by pixel adjustment. Only the angle between the tubes in the joints will vary, but this will not influence the wire length.

During setup procedure, a static pixel spacing can be determined on each display module via a mechanical locking solution and an associated scale. Also, the adjusting of the pixel spacing can be motorised by providing a motor on the line between two diagonal joints at the centre of the back side of the cell structure.

Besides this, horizontal and vertical movement may be added to the entire light diode video display by mounting it on a so-called moving head known from the entertainment industry. By fastening the centre point of the back side to the front of the moving head, it is now possible to move the whole display around.

Cooling of the light diodes in the structural joint may be done by convection by means of the aluminium block of the joint itself, where the cell rods are already secured. Also, the rods may be applied as cooling measure by using heat pipes as rods in the cell construction.

By using this cell chassis structure, spectators are not provided a better display than others, but a new adjusting parameter is added which may either be used for a logistics purpose or an entertainment purpose. It will be a great saving by investing in a new type of light diode video display which is capable of meeting the requirements to pixel spacing of all applications. Also, a motorised adjusting of the pixel spacing will be advantageous during setup, since this may be determined according the conditions of the application. At the same time, this will provide entertainment advantages in the form of programming options to the screen size during an event.

Fastening the entire light video display on a moving head provides entirely new entertainment options in the form of coordinated motion programs. Also, the motion may be used for following people in movement or easy optimising the viewing angle in relation to the audience.

By using heat pipes as rods in the cell construction, the size of the joints may be reduced, thereby enabling to get the joints closer together and resulting in a lesser pixel spacing.

1. A light diode display containing a large number of pixels, the pixels containing a number of light diodes, the light diodes producing light of different colour, where the light diodes are electrically connected to a power supply, and where the pixels or the light diodes also communicate with a control unit, wherein the individual pixels interact with a flexible mechanical construction consisting of a number of interactive rods, that the rods are interconnected by swivel joints, and that pixels are provided on the swivel joints.

2. Light diode display according to claim 1, wherein the rods contain at least the electric connections to pixels or to light diodes.

3. Light diode display according to claim 1 wherein the mechanical construction is designed as a cell, and that the size of the cell is adjustable by changing the distance between two of the joints of the cell.

4. Light diode display according to claim 1, wherein characterised the mechanical construction in the form of a cell contains a scale between at least two joints.

5. Light diode display according claim 1, wherein the frame contains at least one actuator for adjusting the size.

6. Light diode display according claim 1, wherein the actuator of the frame interacts with a motor regulated by a control unit, that a position detector transmits a signal depending on the actual size of the cell to the control unit, and that the control unit regulates the motor to the desired size of the cell.

7. Light diode display according to claim 1, wherein characterised the individual pixels are communicating mutually, or with a controller via two-way wireless communication.

8. Light diode display according to claim 7, wherein communication between pixels takes place by IR communication.

9. Light diode display according to claim 1, wherein the rods of the frame are made of completely or partially transparent material.

10. Light diode display according to claim 1, wherein the rods of the frame contain light diodes.

11. Light diode display according to claim 1, wherein the rods of the frame contain holes for accommodating light diodes.
